(19) United States
(12) Patent Application Publication
(10) Pub. No.: US 2009/0285402 A1
(43) Pub. Date: Nov. 19, 2009

(54) Service induced privacy with synchronized noise insertion

(76) Inventors: Stuart Owen Goldman, Scottsdale, AZ (US); Karl F. Rauscher, Emmaus, PA (US)

Correspondence Address: Lucent Technologies Inc.;Docket Administrator - Room 2F-192, 600-700 Mountain Ave., Murray Hill, NJ, 07974-0636, US

(21) Appl. No.: 12/152,815

(22) Filed: May 16, 2008

(51) Int. Cl. H04L 9/00

(52) U.S. Cl. 380/287

(57) ABSTRACT

A mechanism is disclosed for protecting the privacy of communication content by means of a synchronized noise insertion process operated by counterpart sending and receiving devices. In send mode, a synchronized noise pattern is introduced by a sending device onto a source content, rendering the source content unreadable (or at least partially obfuscating the source content so as to inhibit interception of the content); and in receive mode, a corresponding pattern is introduced 180-degrees out of phase so as to effectively subtract the synchronized noise pattern and yield the original source content. In such manner, communication privacy is achievable without encrypting, encoding or transforming the source content at the sending or receiving device.

### FIELD OF THE INVENTION

This invention relates generally to communication systems and, more particularly to a mechanism for protecting the privacy of communication content by means of a synchronized noise insertion process.

### BACKGROUND OF THE INVENTION

It is a common objective of communication systems to protect the privacy of communication content (i.e., to prevent interception of the content) as it travels from the originator to the designated receiver. This objective is usually accomplished by encrypting or encoding the content by various forms of algorithms (called ciphers), yielding encrypted content that is unreadable to anyone but the originator and the intended receiver. Typically, the receiver possesses special knowledge (called a key) to decrypt the encrypted content so as to yield the original content. Encryption algorithms can range in complexity from very simple codes to very complex mathematical functions; and the type and complexity of encryption may vary depending on the sensitivity of the information content and the communication medium.

As is well known, encryption has long been used by militaries and governments to facilitate secret communication and the encryption keys/codes applicable to such communication must be secured from interception by third parties. Indeed the course of a war can be changed by the interception of a key/code by and decryption of an associated message by an enemy, most particularly if it is accomplished without knowledge of the sender. Because of the sensitivity in this area, different governments have promulgated various laws, registration requirements, export controls and the like to control and/or regulate the release of encryption information, including algorithms and keys.

It is contemplated that in certain instances, a need exists to protect the contents of a communication without relying on an encryption scheme that is subject to governmental controls and regulations, and in such case the burden of the governmental controls and regulations associated with encryption information may be advantageously avoided to the extent possible and legally permissible.

### SUMMARY OF THE INVENTION

This need is addressed and a technical advance is achieved in the art by providing a mechanism for protecting the privacy of communication content by means of a synchronized noise insertion process operated by sending and receiving devices. At the sending device, a synchronized noise pattern is introduced onto a source content, rendering the source content unreadable (or at least partially obfuscating the source content so as to inhibit interception of the content); and at the receiving device, the pattern is subtracted so as to yield the original source content. In such manner, communication privacy is achievable without encrypting, encoding or transforming the source content at the sending or receiving device.

In one embodiment, there is provided a method, carried out by a sending device, for protecting privacy of information content to be communicated to a receiving device. The sending device first obtains information content to be communicated to the receiving device, the information content defining source content. The sending device next obtains a synchronized noise pattern. The sending device then combines the source content with the synchronized noise pattern, yielding a composite signal. The synchronized noise pattern at least partially obfuscates the source content so as to inhibit third party detection of the source content from the composite signal.

In another embodiment, there is provided a corresponding method, carried out by a receiving device to subtract the synchronized noise pattern and yield the original source content. The receiving device receives a composite signal comprising source content combined with a first synchronized noise pattern (i.e., introduced by a sending device). The receiving device next obtains a second synchronized noise pattern corresponding substantially to the first synchronized noise pattern. The receiving device then combines the second synchronized noise pattern with the composite signal, in time synchronization and 180-degrees out of phase relative to the first synchronized noise pattern, effectively subtracting the first synchronized noise pattern and yielding an output signal corresponding substantially to the original source content.

In still other embodiments, there is provided a communication device including an input element for receiving information content; a synchronized noise insertion element for combining a synchronized noise pattern with the received information content; and an output element for producing an output signal characterizing the combination of synchronized noise pattern with the received information content. In one embodiment, the communication device is operable in a send mode to send a composite output signal to a counterpart device wherein the synchronized noise pattern introduced by the communication device in the send mode at least partially obfuscates the information content in the composite output signal. In another embodiment, the communication device is operable in a receive mode to receive information content that is at least partially obfuscated by a synchronized noise pattern introduced by a counterpart device, the synchronized noise pattern introduced by the communication device in the receive mode operates to effectively erase the synchronized noise pattern and yield the original information content.

### BRIEF DESCRIPTION OF THE DRAWINGS

The foregoing and other advantages of the invention will become apparent upon reading the following detailed description and upon reference to the drawings in which:

FIG. 1 is a block diagram of an exemplary communication network including a sending device and receiving device executing a synchronized noise insertion process according to an embodiment of the present invention;

FIG. 2 is a block diagram of a sending device executing a “send” synchronized noise insertion process according to an embodiment of the present invention; and

FIG. 3 is a block diagram of a receiving device executing a “receive” synchronized noise insertion process according to an embodiment of the present invention.

### DESCRIPTION OF THE PREFERRED EMBODIMENT(S)

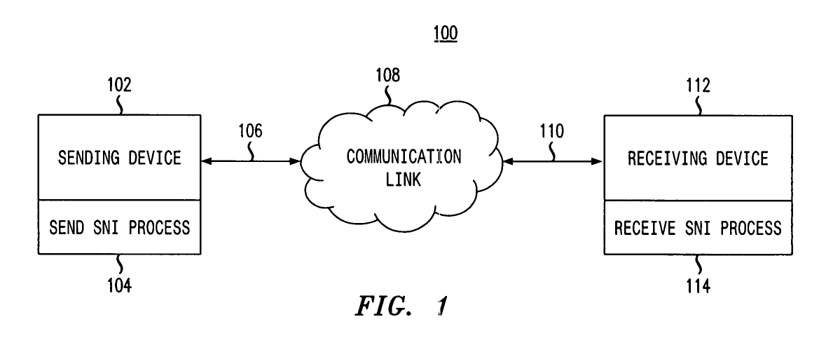

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an exemplary communication network 100 in which principles of the present invention may be implemented. The communication network 100 may be implemented in network topologies including, for example and without limitation, wireless or wireline implementations, IP- or IMS-based topologies or combinations thereof.

Communication network 100 serves a plurality of communication devices (two shown) including a sending device 102 and a receiving device 112. The sending device 102 comprises generally any communication device having a processor and memory (not shown) and configured to send information content, including without limitation, voice, video, image, text, data or multimedia content via the communication network 100 to a receiving device. The receiving device 112 generally comprises any communication device having a processor and memory (not shown) and configured to receive information content, including without limitation, voice, video, image, text, data or multimedia content via the communication network 100. The communication devices 102, 112, may comprise, for example and without limitation, mobile phones, wireline phones, PDAs, VoIP phones or SIP phones, laptops or desktop computers, servers, routers or the like.

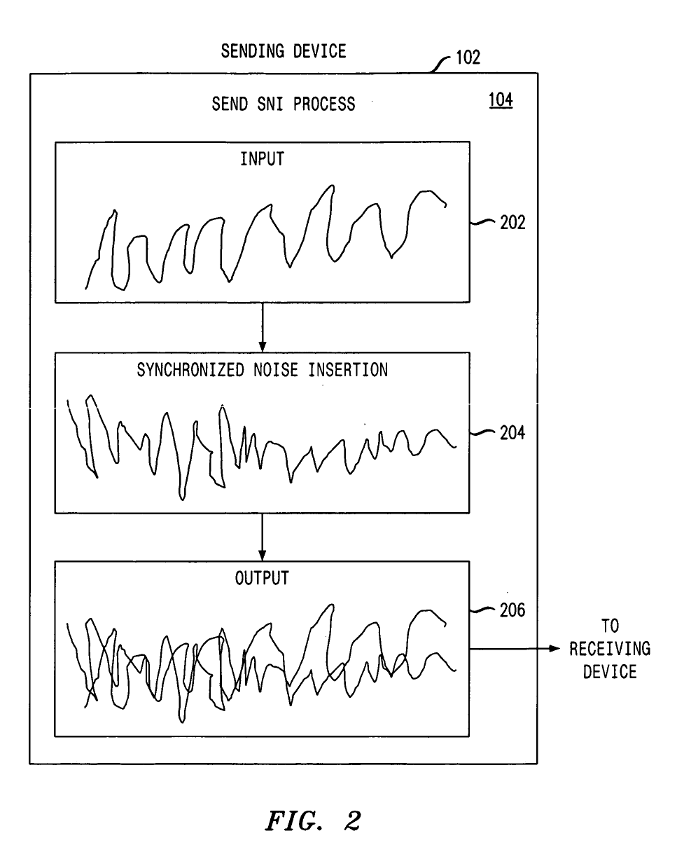

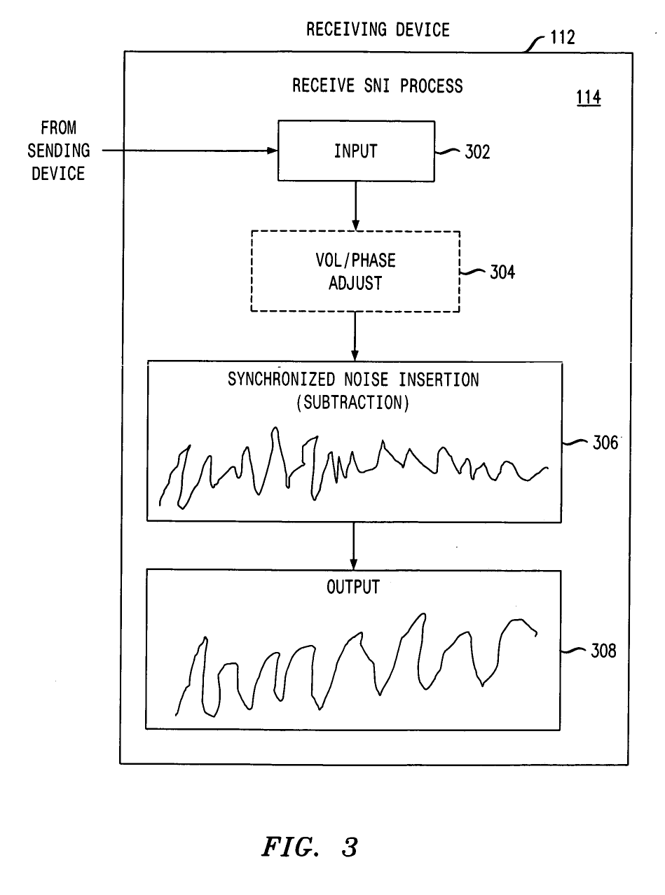

The sending device 102 includes a “Send” Synchronized Noise Insertion function (“Send SNI Process”) 104 operable to introduce a synchronized noise pattern onto source content, rendering the source content unreadable (but without encrypting or encoding the content); and the receiving device 112 includes a “Receive” Synchronized Noise Insertion function (“Receive SNI Process”) 114 operable to remove the synchronized noise pattern (but without decrypting or decoding the content) so as to yield the original source content. Operation of the Send SNI Process and Receive Process will be described in greater detail in relation to FIG. 2 and FIG. 3.

The sending and receiving devices 102, 112 communicate via one or more functional links (three shown) 106, 108, 110 which may comprise, for example, terrestrial or wired links, satellite links, switches, gateways, interconnecting networks or the like. As will be appreciated, the functional links may implement generally any air interface, circuit or packet switching technology presently known or devised in the future.

Now referring to FIG. 2, an embodiment of the Send SNI Process 104 will be described in greater detail. As shown, the Send SNI Process 104 is operable to execute functions including an input function 202, synchronized noise insertion (SNI) function 204 and output function 206. For convenience and to enhance clarity of the description, FIG. 2 shows exemplary waveforms corresponding to the various functions shown; and the exemplary waveforms will be identified with reference to their corresponding functions. However, it will be appreciated that the Send SNI Process is not limited to operation with the waveforms shown, neither is the Send SNI Process limited to the specific functions shown. In one embodiment, the functions of the Send SNI Process are implemented on any computer-readable signal-bearing media residing within the sending device 102. The computer-readable signal-bearing media store software, firmware and/or assembly language for performing one or more functions relating to FIG. 2. The computer-readable signal-bearing media may comprise, for example and without limitation, floppy disks, magnetic tapes, CD-ROMs, DVD-ROMs, hard disk drives or electronic memory.

The input function 202 obtains (e.g., receives or generates) information content, including without limitation, voice, video, image, text, data or multimedia content (hereinafter defining “source content”) and communicates the source content to the SNI function 204. For purposes of example and without limitation, FIG. 2 shows an analog information-bearing signal (“bearer signal”) characterizing the source content. However, as will be appreciated, the source content may characterize virtually any analog or digitized bearer signal or real content that is to be communicated to a receiving device 112.

The SNI function 204 introduces a synchronized noise pattern on top of the source content, yielding a composite (i.e., source+noise) signal; and the output function 206 transmits the composite signal to the receiving device 112. In one embodiment, the noise pattern is retrieved from a plurality of patterns stored in memory (not shown) corresponding to a plurality of pattern identifiers; and the relevant pattern identifier is included in the synchronized noise pattern along with one or more synchronization flags, signals or the like (not shown) to facilitate later extraction of the pattern from the composite signal by the receiving device 112. The patterns may be stored internally or externally to the sending device 102.

Advantageously, the synchronized noise pattern at least partially obfuscates or “masks” the source content so as to inhibit third party detection of the source content from the composite signal. For purposes of example and without limitation, the SNI function block 204 shows a characteristic noise pattern comprising an analog noise signal; and the output function block 206 shows a composite signal representing the combination of the analog noise signal with the analog bearer signal from input function 202. As will be appreciated, the characteristic noise pattern may comprise virtually any analog or digital signal or information content introduced on top of the source content. The characteristic noise pattern may be relatively simple or complex depending on the degree the sender wishes to mask the source content.

Now referring to FIG. 3, an embodiment of the Receive SNI Process 114 will be described in greater detail. As shown, the Receive SNI Process 114 is operable to execute functions including an input function 302, volume/phase adjust function 304, synchronized noise insertion (SNI) function 306 and output function 308. For convenience and to enhance clarity of the description, FIG. 3 shows exemplary waveforms corresponding to the various functions of the Receive SNI Process that are based on the exemplary waveforms described in relation to FIG. 2. However, the Receive SNI Process is not limited to operation with the waveforms shown or the specific functions shown. In one embodiment, the functions of the Receive SNI Process are implemented on any computer-readable signal-bearing media residing within the receiving device 112. The computer-readable signal-bearing media store software, firmware and/or assembly language for performing one or more functions relating to FIG. 3. The computer-readable signal-bearing media may comprise, for example and without limitation, floppy disks, magnetic tapes, CD-ROMs, DVD-ROMs, hard disk drives or electronic memory.

The input function 302 receives an input signal comprising the composite signal generated by the Send SNI Process 104 subject to signal impairments that may have occurred during transmission from the sending device 102 to the receiving device 112. The signal impairments may yield an input signal, for example, having a different amplitude or phase relative to the composite signal. The optional volume/phase adjust function 304 is operable to adjust the amplitude or phase of the input signal accordingly, to compensate for signal impairments.

The SNI function 306 removes the noise from the received signal (or if applicable, from the adjusted received signal) by inserting the same characteristic noise pattern that was originally introduced by the Send SNI Process, but 180 degrees out-of-phase so as to effectively subtract the originally introduced pattern from the received signal. Optionally, the volume/phase adjust function 304 may operate to further adjust the amplitude or phase of the inserted noise pattern to account for signal impairments or the like during transmission. Adjustments for the inserted noise may be linear or nonlinear along the frequency spectrum of the noise pattern.

For purposes of example and without limitation, the SNI function block 306 shows a characteristic noise pattern comprising the analog noise signal introduced by the Send SNI Process offset by 180 degrees. In one embodiment, the SNI function 306 determines the characteristic pattern to be inserted onto the received signal and the proper alignment of the characteristic pattern relative to the received signal based on the pattern identifier and synchronization flags in the received signal. As will be appreciated, the noise pattern may be retrieved from a plurality of patterns stored in memory (not shown) corresponding to a plurality of pattern identifiers. The patterns may be stored internally or externally to the receiving device 112. The stored patterns may correspond exactly to the original patterns (and the 180 degree phase delay introduced by the SNI function 306 after retrieval of the stored pattern) or the stored patterns may be “pre-delayed” 180 degrees out-of-phase relative to the original patterns.

The output function 308 receives or detects an output signal produced by application of the phase-adjusted noise pattern onto the received signal. Advantageously, the output signal will correspond substantially to the original bearer signal characterizing the source content (i.e., the input function block of the Send SNI Process 104) such that the source content can be understood or derived from the output signal. For purposes of example and without limitation, the output function block 308 of FIG. 3 shows substantially the same analog bearer signal as the input function block 202 of FIG. 2. The output function may further generate a playback, display or the like of the output signal to a user of the receiving device via an appropriate user interface (not shown). In such manner, the source content is communicated to a user of the receiving device without encrypting or encoding the source content at the sending device or decrypting or decoding encrypted source content at the receiving device.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The invention may be deployed in legacy telephony networks as well as next-generation networks carrying voice, video, text and/or data. It may be deployed in virtually any communication topology including, but not limited to wireline SS7, wireless, IP and IMS networks. The scope of the invention is, therefore, indicated by the appended claims rather than by the foregoing description. All changes that come within the meaning and range of equivalency of the claims are to be embraced within their scope.

What is claimed is:

1. A method, carried out by a sending device, for protecting privacy of information content to be communicated to a receiving device, the method comprising:
obtaining information content to be communicated to the receiving device, the information content defining source content;
obtaining a synchronized noise pattern; and
combining the source content with the synchronized noise pattern, yielding a composite signal, the synchronized noise pattern at least partially obfuscating the source content so as to inhibit third party detection of the source content from the composite signal.

2. The method of claim 1, further comprising sending the composite signal to the receiving device.

3. The method of claim 1, wherein the source content comprises an analog information-bearing signal characterizing one or more of voice, video, image, text, data or multimedia content.

4. The method of claim 1, wherein the source content comprises a digitized information-bearing signal characterizing one or more of voice, video, image, text, data or multimedia content.

5. The method of claim 1, wherein the synchronized noise pattern comprises an analog signal.

6. The method of claim 1, wherein the synchronized noise pattern comprises a digital signal.

7. The method of claim 1, wherein the step of obtaining a synchronized noise pattern comprises selecting the synchronized noise pattern from among a plurality of characteristic noise patterns.

8. The method of claim 1, wherein the synchronized noise pattern includes a pattern identifier and at least one synchronization symbol, the step of combining yielding a composite signal including the pattern identifier and synchronization symbol.

9. A method, carried out by a receiving device, comprising:
receiving a composite signal comprising source content combined with a first synchronized noise pattern;
obtaining a second synchronized noise pattern corresponding substantially to the first synchronized noise pattern; and
combining the second synchronized noise pattern with the composite signal, in time synchronization and 180-degrees out of phase relative to the first synchronized noise pattern, yielding an output signal corresponding substantially to the source content.

10. The method of claim 9 further comprising adjusting at least one of the amplitude and phase of the composite signal before combining the second synchronized noise pattern with the composite signal.

11. The method of claim 9 further comprising adjusting at least one of the amplitude and phase of the second synchronized noise pattern before combining the second synchronized noise pattern with the composite signal.

12. The method of claim 9 wherein the step of obtaining a second synchronized noise pattern comprises selecting a second synchronized noise pattern from among a plurality of characteristic noise patterns based on a pattern identifier of the first synchronized noise pattern identified in the composite signal.

13. A communication device comprising:
an input element for receiving information content;
a synchronized noise insertion element for combining a synchronized noise pattern with the received information content; and
an output element for producing an output signal characterizing the combination of synchronized noise pattern with the received information content,
the communication device operable in a send mode to send a composite output signal to a counterpart device wherein the synchronized noise pattern introduced by the communication device in the send mode at least partially obfuscates the information content in the composite output signal.

14. A communication device comprising:
an input element for receiving information content;
a synchronized noise insertion element for combining a synchronized noise pattern with the received information content; and
an output element for producing an output signal characterizing the combination of synchronized noise pattern with the received information content,
the communication device operable in a receive mode to receive information content that is at least partially obfuscated by a synchronized noise pattern introduced by a counterpart device, the synchronized noise pattern introduced by the communication device in the receive mode operates to effectively erase the synchronized noise pattern and yield the information content.
